(19) United States
(12) Patent Application Publication
(10) Pub. No.: US 2012/0288852 A1
(43) Pub. Date: Nov. 15, 2012

(54) Force Mediated Assays

(76) Inventors: Richard Willson, Houston, TX (US); Paul Ruchhoeft, Missouri City, TX (US)

(21) Appl. No.: 13/522,319

(22) PCT Filed: Jan. 15, 2011
(86) PCT No.: PCT/US2011/000075

§ 371 Date: Jul. 14, 2012

Related U.S. Application Data
(60) Provisional application No. 61/336,106, filed on Jan. 15, 2010.

(51) Int. Cl. G01N 21/75; G01N 21/55; G01N 21/65; G01N 21/64; G01N 21/76; B82Y 15/00

(52) U.S. Cl. 435/5; 436/501; 436/172; 436/164; 435/29; 435/7.2; 436/86; 436/94; 435/4; 435/7.1; 436/71; 436/87; 977/774; 977/902

(57) ABSTRACT

A sensitive and specific method of detecting chemical species, viruses and microorganisms is presented to improve performance of molecular-recognition-based assays utilizing particles decorated with molecular recognition agents such as antibodies and DNA probes, and observing analyte-dependent changes in the response of the particles to forces such as magnetic or gravitational forces or Brownian thermal fluctuations.

### CROSS REFERENCE TO RELATED APPLICATIONS

This application claims the benefit of U.S. provisional Ser. No. 61/336,106, filed Jan. 15, 2010 by the present inventors.

### FIELD OF THE INVENTION

The present invention relates generally to chemical analysis, and more particularly, to assays for biological analytes using force as an element of the assay method.

### BACKGROUND OF THE INVENTION

The detection of chemical analytes, including toxins and industrial chemicals as well as biological molecules, cells, viruses, and pathogens, is of great importance in modern society. Environmental health and safety, chemical and biological defense, sample identification, biomedical investigations, and medical diagnostics all depend upon reliable detection and quantitation of chemical and biological species and organisms.

Biological research and medical practice are particularly dependent upon methods of detecting and quantitating molecules, viruses and cells. Of particular importance are the detection of pathogens such as bacteria, parasites, and viruses, and the detection of proteins and nucleic acids, among other examples identified in Table 1.

Detection and quantitation of these types of analytes is increasingly important in the investigation of biological processes, including in areas known as proteomics, genomics, epigenetics, and interactomics.

Practical applications include diagnosing infections with pathogenic cells and viruses, protecting against bioterrorism, and diagnosing infectious diseases. Specific biomarkers, including microRNAs, proteins and modified proteins are useful in diagnosing cancer, in choosing which therapeutic drugs to use, in detecting relapse, and in identifying the appearance of drug resistance among other examples identified in Table 1.

A very large range of organisms, viruses, and chemical species, collectively referred to as analytes, are of interest in modern science, technology and medicine. Illustrative examples of these are listed in Table 1, which does not constitute a complete listing. There is a felt need for detection and analysis methods combining desirable characteristics such as high sensitivity, convenience and reliability, low cost, speed, and/or the ability to be performed in parallel on multiple analytes.

The analytical method to be employed depends, in part, on the origins of the species to be detected and the example within which they are to be detected. Some examples are listed in Table 1, and include medical specimens, environmental samples, and food.

The overall analytical process nearly always includes some sample-preparation steps using various sample preparation agents, some of each of which are illustrated in Table 1. These may include, for example, concentration of a dilute species from a liquid or gaseous environment using a filter, isolation of a subset of cells from a complex blood sample, breakage of cells to liberate analytes of interest, or removal of lipids and particulates which could interfere with later analysis.

In addition to concentrating, enriching, and/or partially-purifying the analytes of interest, in some cases, it is possible to achieve amplification of the analyte to be detected, for example, by the use of polymerase chain reaction to amplify nucleic acids or nucleation chain reaction to amplify prion proteins. Where available, these methods can greatly facilitate subsequent analysis.

Many analytical methods, including those of interest in the present invention, involve molecular recognition, and also transduction of the molecular recognition event into a usable signal. Molecular regulation refers to the high affinity and specific tendency of particular chemical species to associate with one another, or with organisms or viruses displaying target chemical species. Well-known examples of molecular recognition include the hybridization of complimentary DNA sequences into the famous double helix structure with very high affinity, and the recognition of foreign organisms or molecules in the blood stream by the antibodies produced by mammals, or selected analytes by deliberately selected monoclonal antibodies.

As partially listed in Table 1, there are many other examples of molecular recognition elements, including the recognition of carbohydrate molecules by lections, nucleic acid recognition by proteins and nucleic acid analogs, the binding of analytes by antibody fragments, derivatives, and analogs, and a host of other examples.

A complete method of detection and analysis requires, in addition to molecular recognition, some means of reading out of molecular recognition event into a usable signal. This reading-out or transduction is the main focus of the present invention. Because of the importance of detection, analysis, and quantitation of chemical and biological species, the prior art contains many examples of technologies for carrying out these analyses. The prior art technologies mostly employ conventional molecular recognition elements, especially antibodies and nucleic acids, and have varied primarily in the means of transducing molecular recognition into a useful signal.

In particular, successive generations of means of labeling antibodies and nucleic acids so that their binding to a target analyte may be more easily detected have shaped large portions of the field for decades. Successive generations of these types of assays have involved immobilizing the target analyte onto a solid planar surface, typically a membrane or the flat bottom of a microtiter plate well, either by non-specific absorption or by antibody capture in most cases. Then a labeled molecular recognition element such as a nucleic acid probe or antibody is added and allowed to bind to the immobilized analyte. After washing, the label is detected and the presence of the label is used to infer the presence of the analyte on the surface, and therefore in the original sample.

Labels have included radioactive isotopes, enzymes with reactive substrates capable of generating color, light or fluorescence, or fluorescent molecules directly coupled to the molecular recognition agent. These types of solid-phase binding assay have been enormously useful and influential and are widely practiced to this day. They suffer in some cases from a lack of sensitivity, from the relatively laborious steps involved and in successive binding and washing (complicated by the difficulties of mass-transfer to the solid phase).

Other types of assays have been pursued, though they have not achieved the broad utilization of the solid-phase binding assays. Of particular interest are homogeneous assays, in which binding (or the suppression of binding, or competition) gives rise to the presence or absence of a signal. Examples of this sort of assay include the assembly of functional enzymes from split domains, the appearance of fluorescence when certain dyes intercalate into double-stranded nucleic acids, and molecular beacons which become fluorescent after a conformational change induced by the presence of a hybridization partner nucleic acid strand.

Tracking of particles and labels (in one or many interrogation areas) is common, though not much used for assays of analytes. The well-known lateral-flow assay involves the capture of particulate and/or enzymatic labels at pre-selected locations when analyte is present to bridge them to capture antibodies. Particle tracking is widely performed in 2 and 3 dimensions for velocimetry; particle image velocimetry (derived from laser speckle velocimetry) also is widely used for velocimetry. These methods can use a wide variety of methods of illumination and imaging, some of which are listed in Table 1. Of particular importance are time-varying, strobed, and sheet illumination, and observation by fluorescence and light scattering. Particle motion and tracking can also be used to characterize particles themselves, as in dynamic light scattering and in the nanoparticle tracking analysis practiced by Nanosight, Inc.

Also related to the present invention is Yang et al., PCT/US2006/062578 titled “Single nanoparticle tracking spectroscopic microscope” (filed 22 Dec. 2006), which describes methods of optical tracking of single particles. Yang et al., however, do not teach the use of particle tracking in detecting or quantitating analytes in any way.

Most closely related to the present invention, optical signals from nanoparticles have been used to detect analytes using molecular recognition elements of the sorts suitable for use in the present invention. For example, Huo et al. in PCT/US2009/030087 titled “Detection of analytes using metal nanoparticle probes and dynamic light scattering” (filed 5 Jan. 2009) teach the use of metal nanoparticles decorated with antibodies in a homogeneous assay for detecting biomolecules, including proteins. Huo et al., however, teach dynamic light scattering as the method of monitoring changes in the particles induced by the presence of analyte, with indefinite aggregation of the particles being a desired outcome, and no monitoring of single particles or their motion or force-responsiveness. This technology is expected to be less sensitive and specific than that of the present invention, and to be far more susceptible to false signals created by particulate matter associated with biological, medical, and environmental samples.

### BRIEF SUMMARY OF THE INVENTION

The present invention provides a methodology for bioassays and diagnostics in which a force, such as, but not limited to, fluid motion, magnetic, electrophoretic, dielectrophoretic, or gravitational force, modulates an optical, electromagnetic, or imaging signal in response to the presence of a pathogen or analyte of interest. Both forces and detection methods are further listed in Table 1. The described methodology is generally applicable to most pathogen assays and molecular diagnostics. The present invention also leads to enhanced sensitivity and convenience of use.

The methodology in one aspect includes a method of assaying an analyte including at least the steps of: contacting the analyte with a plurality of particles of diameter less than 3 mm, the particles being capable of interacting with the analyte by binding, adsorption or reaction; observing the motion of some or all of the particles by optical, fluorescence, or other electromagnetic measurement system; and using the presence of particles with differing motion to infer the presence or concentration of the analyte.

The methodology in another aspect includes a system for determining the presence or concentration of an analyte, the system including at least: particles capable of interacting with the analyte by adsorption, binding or reaction; a liquid in which the particles can move; and a measurement system for electromagnetically observing the motion of the particles, either individually or in groups.

The methodology in another aspect includes a method of assaying an analyte comprising the steps of: contacting the analyte with a plurality of particles of diameter less than 3 mm, the particles being capable of interacting with the analyte by binding, adsorption or reaction and having an anisotropically-distributed detectable optical property, in the presence of a force field which acts to make the distribution of orientations of the particles non-isotropic; measuring the optical property of some or all of the particles by eye, or using a system for camera, digital camera, PMT, scanner, microscope, telescope, detector array, time-gated, chopped, frequency-modulated, wavelength-filtered, polarization-sensitive, Raman, Surface-enhanced Raman, high numerical aperture, color-sensitive, lifetime, FRET, FRAP, intensified, phosphorescence, resistivity, ellipsometer, or high-density CCD detection, and using changes in the observed optical property to infer the presence or concentration of the analyte.

A method of assaying an analyte including at least the steps of: contacting the analyte with a plurality of particles of diameter less than 3 mm, said particles being capable of interacting with the analyte by binding, adsorption or reaction and having a detectable optical property such as, for example, specular reflectivity, fluorescence or phosphorescence, and simultaneously contacting the analyte with a second species capable of interacting with the analyte by binding, adsorption or reaction and responsive to forces imposed by Brownian energy fluctuations, fluid shear, a magnetic field, a magnetic field gradient, centrifugal force, field/flow fractionation forces, fluid flow force, electrophoretic force, dielectrophoretic force, Coriolis force, or Maringoni effect force; imposing a force to which the second species is responsive, in such a manner as to concentrate the second species in a region; measuring the detectable optical property in said region by eye, or using a system for camera, digital camera, PMT, scanner, microscope, telescope, detector array, time-gated, chopped, frequency-modulated, wavelength-filtered, polarization-sensitive, Raman, Surface-enhanced Raman, high numerical aperture, color-sensitive, lifetime, FRET, FRAP, intensified, phosphorescence, resistivity, ellipsometer, or high-density CCD detection, and using increases in the observed optical property in the region to infer the presence or concentration of the analyte.

A method of assaying an analyte including at least the steps of: contacting the analyte with a plurality of particles of diameter less than 3 mm, said particles being capable of interacting with the analyte by binding, adsorption or reaction and having a detectable optical property, and also being susceptible to force applied by a magnetic field, centrifugation, ultracentrifugation, fluid shear, sonication, buoyancy (e.g., with microbubbles), electrophoresis, capillary electrophoresis, dielectrophoresis, vibration or shock; contacting the analyte with a second species capable of interacting with the analyte by binding, adsorption or reaction and bound to a surface; imposing a force to which the particle is responsive, in such a manner as to remove at least half the particles from the surface in the absence of the analyte; measuring the detectable optical property in said region by scanning electron microscopy (SEM), fluorescence microscopy or scanning probe microscopy (e.g., near-field scanning optical microscopy (NSOM), magnetic force microscopy (MFM), scanning tunneling microscopy (STM), atomic force microscopy (AFM), or parallel multiprobe scanning microscopy, and using the presence of the particles on the surface to infer the presence or concentration of the analyte.

1. Bioassays using reorientation as reporter. In one embodiment, slightly-buoyant spherical particles 2.8 μm in diameter are decorated with antibodies to a target and fluors over their whole surface. These antibodies and fluors are then destroyed on one side of the spheres using an ion beam. Antibodies can be replaced or supplemented with DNA probes, aptamers, cells, enzymes, PNA (peptide nucleic acid chimera), lectins, substrates, cells, carbohydrates, etc. The spheres are mixed with a sample, and with gold nanoparticles bearing antibodies to the same target. If the target is present, the nanoparticles weight the spheres such that they spend more time with their fluorescent side pointing down, and fluorescence observed from below is increased.

Alternatively, particles can be fabricated with fluorescent material on one side and antibodies on the other, or a number of other combinations, to achieve the same effect. Particles used in the present bioassays are synthesized as macroscopic particles that are comprised of at least two physically or chemically different surface referred to as Janus particles. Furthermore they can be electrophoretically-reorientable such as E-Ink in the Kindle™ reader.

The forces underlying the molecular recognition in such bioassays include but not limited to magnetic, electrophoretic, dielectrophoretic, or gravity force with dense particle binding, or fluid shear, or gravity with buoyant particles like micro bubbles.

The result of such force induces a change in reorientation, average reorientation, changes in rotational or spatial diffusional mobility, settling, flotation, or signal strength, particularly through movement behind an opaque or semi-opaque surface.

Readout can either be fluorescence (including lifetime), phosphorescence (including after pulsed excitation), reflection, polarization, scattering, absorbance, chemiluminescence, magnetic, or conductivity.

2. Bioassays using reflection as reporter. The flakes in a snow globe are intensely bright when correctly oriented to give specular reflection. Similar methods as above can be used to perturb the average orientation of flakes or retro reflectors, or the dynamics of their orientation or re-orientation. Perturbing force could be applied in a cyclic way to accentuate the signal of interest. Brightness can be observed overall, or on an individual reflector basis. Autocorrelations and transit times can be calculated. Machine vision and software processing will be useful for automation and improved sensitivity.

Another approach to this type of bioassay is to modulate the reflection brightness of flat mirrors, force-sensitive reflectors, or retro reflectors. Force can be exerted by magnetic force, electrophoretic force, hydrostatic pressure, centrifugal force, or forces associated with fluid shear. A similar approach is to use scattering particles, including particles which are engineered or chosen to have high or anisotropic scattering properties. Mobility (translational and/or rotational) is monitored on a single-particle basis by particle tracking. Mobility modification can be induced by (e.g., antibody-mediated) binding of moieties such as polymers which enhance drag, as well as aggregation, density modification, magnetic response, etc. Tracked particles can be either fluorescent, as small as single quantum dots, Janus particles, and/or tethered to a surface.

3. Bioassays using relocation as reporter. Modification of the susceptibility of a label to be moved by a force such as, but not limited to, magnetic, gravitational, centrifugal, electrophoretic, Brownian forces, fluid shear upon binding of an analyte or reporter or both are used to signal the presence of the analyte. For example, in the presence of an analyte an anti-analyte-antibody-bearing retroreflector can be bridged to a magnetic particle bearing antibodies to the same analyte. The presence of the analyte is signaled by the mobilization/relocation of retroreflectance in a magnetic field. Similarly, the binding of buoyant microbubbles, dense gold nanoparticles, or highly charged moieties facilitate the physical relocation of reporters, or keep them attached to a surface in the presence of a magnetic or centrifugal force that tend to remove them.

### BRIEF DESCRIPTION OF THE SEVERAL VIEWS OF THE DRAWINGS

For a more complete understanding of the present invention, reference is now made to the following drawings, in which,

FIG. 1 shows magnetic relocation of an optically-detectable label in the presence of a targeted analyte.

FIG. 2 illustrates an assay for detecting analytes based on reorientation of fluorescent Janus particles.

FIG. 3 shows detecting microRNAs analytes by changes in the brightness and single-particle mobility of nanoparticles.

FIG. 4 illustrates detecting analytes by changes in the alignment of reflective magnetic-core flakes.

FIG. 5 illustrates the detection of microRNA molecules by binding of nanoparticles and detection by scanning electron microscopy.

### DETAILED DESCRIPTION OF THE INVENTION

In the following detailed description, reference is made accompanying drawings that illustrate embodiments of the present invention. These embodiments are described in sufficient detail to enable a person of ordinary skill in the art to practice the invention without undue experimentation. It should be understood, however, that the embodiments and examples described herein are given by way of illustration only, and not by way of limitation. Various substitutions, modifications, additions, and rearrangements may be made without departing from the spirit of the present invention. Therefore, the description that follows is not to be taken in a limited sense, and the scope of the present invention is defined only by the appended claims.

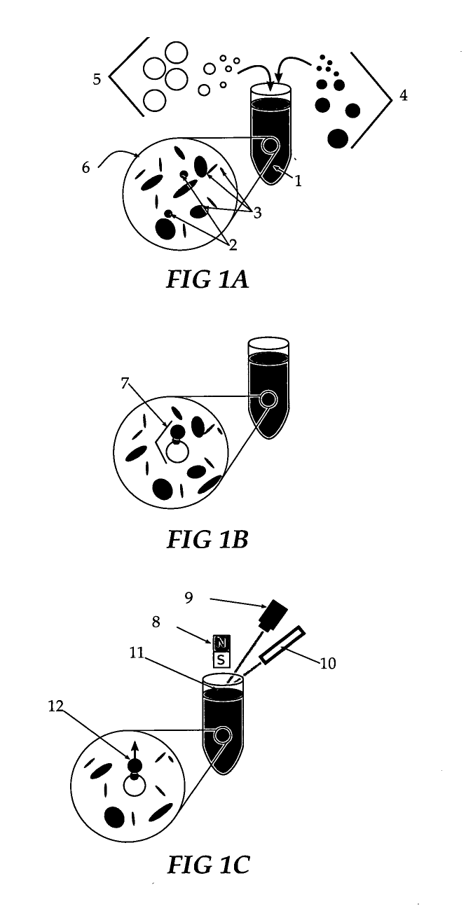

Turning now to FIG. 1A, a sample 1 containing a virus 2 to be detected along with other contaminants 3 is contacted with paramagnetic particles 4 and optically-detectable labels 5. Both the magnetic particles 4 and the optically-detectable labels 5 bear antibodies to the virus 2 which is to be detected. Note that 6 is an expanded view of sample 1.

As shown in FIG. 1B, an expanded view shows that the virus particles bind to both the magnetic particles and the optically-detectable labels, merging them into a single assemblage 7 which is both magnetically responsive and optically-detectable. Turning now to FIG. 1C, the application of a magnetic field 8 draws and accumulates the magnetic particles to a detection location 11 where they are optically imaged by detection system 9 and 10. In the absence of the target virus, the magnetic particles 4 accumulate at the detection location 11 but no optically-detectable labels are present. If the target virus analyte is present, the magnetic particles carry along with themselves the optically-detectable label 12, and the label is detected at the detection location 11. The accumulation of the optically-detectable label at the detection location 11 is used as evidence for the presence of the virus 2 in the original sample 1.

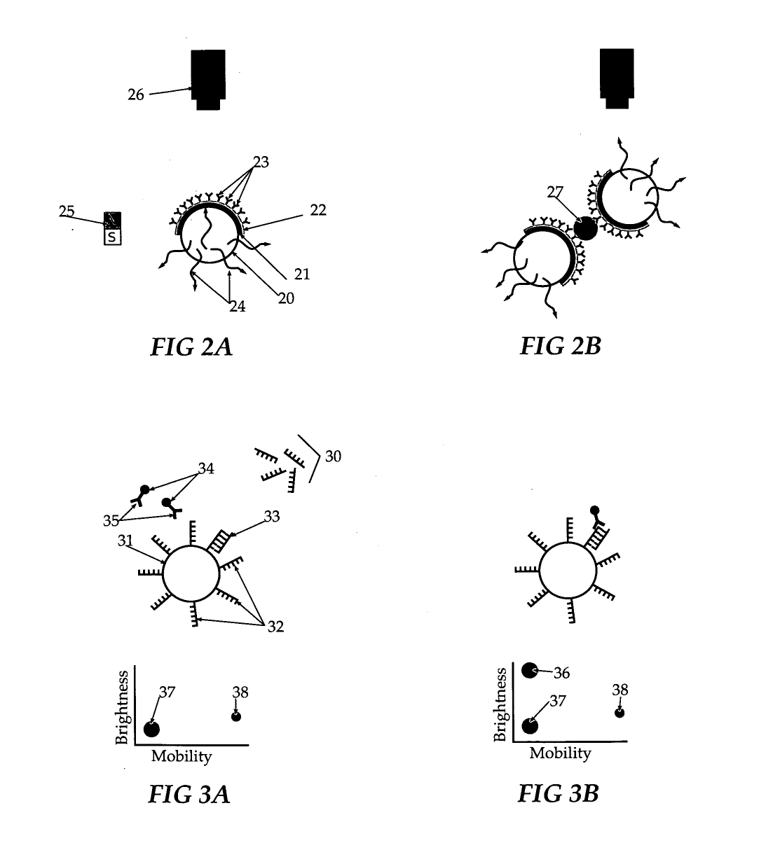

Turning now to FIG. 2, as shown in FIG. 2A, fluorescent particles 20 are coated with an opaque magnetic coating 21 and a gold coating 22 on one side to make Janus particles of which one side is opaque and the other side is fluorescent because the opaque coating is absent on that side. The gold coating 22 is decorated with antibodies 23.

The particles are suspended in solution. When illuminated with light of the fluorescent particles' 20 excitation frequency, fluorescence emission 24 is observed from each particle when it is appropriately oriented to be excited by the illumination light and for its emissions to be captured by the fluorescent detection system. The particles are subject to rotational Brownian diffusion, and spend only a portion of their time facing in any given direction.

When a magnetic field 25 is applied to the suspension of particles, they tend to align with the magnetic field, such that their orientation is no longer uniformly distributed and they spend more time oriented with the magnetic field. If illumination by the excitation light is provided from a direction in which the opaque coating tends to face in the magnetic field, the amount of fluorescence excitation is greatly reduced, and the amount of emission 24 is relatively low. Similarly, if the fluorescence detection system 26 observes the particles from the direction in which the opaque coating tends to be oriented in the magnetic field, emission is blocked, and the fluorescence signal is relatively low. Turning to FIG. 2B, after the addition of a target analyte 27, the analyte bridges the particles together via the antibodies 23 on their surfaces, producing dimers and larger assemblies. When a magnetic field is applied to these assemblies of particles, they no longer can align themselves as effectively with the emitted field, and fluorescent emission is observed by detection system 26, signaling the presence of the analyte.

Turning now to FIG. 3, as shown in FIG. 3A, isolated nucleic acids 30 from a human blood sample are mixed with a suspension of 200 nm polyacrylamide particles 31 decorated with DNA probe oligonucleotides 32 specific to a particular microRNA 33, and then a suspension of 20 nm gold particles 34 bearing an antibody specific to RNA/DNA hybrids 35 is added. Single-particle tracking by light scattering is used to measure the scattering brightness and mobility of 10,000 particles. The presence and number of a lower-mobility, higher-scattering population 36 of particles (FIG. 3B) at higher fractional concentration than seen in a control sample containing only the two types of particles 37 and 38 is used to infer the presence and concentration of the miRNA 33.

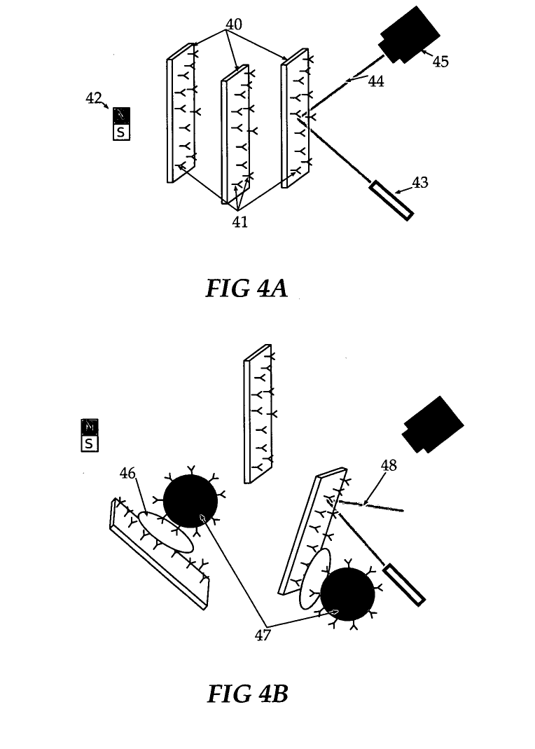

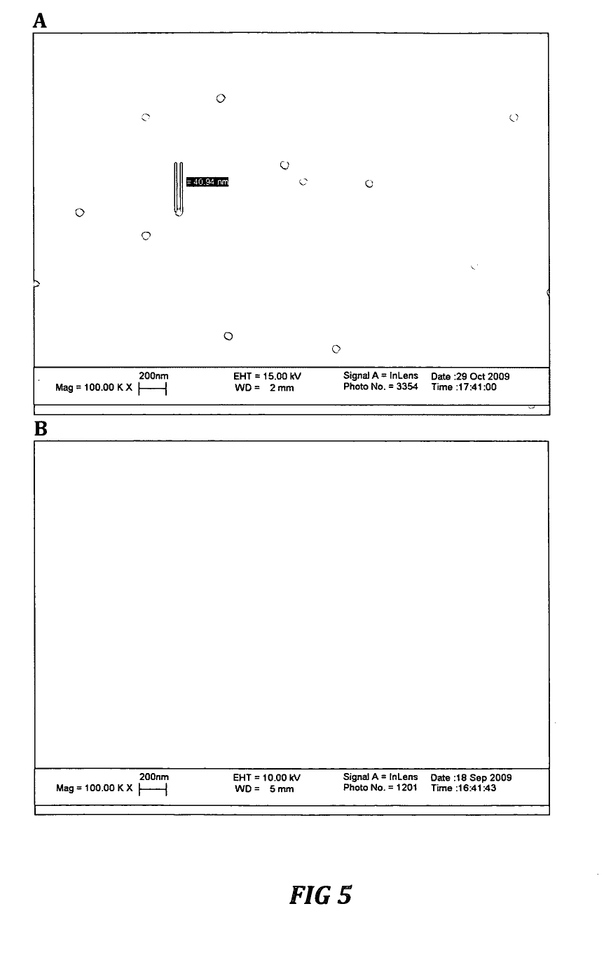

Turning now to FIG. 4, as shown in FIG. 4A, gold flakes with a magnetic core 40, bearing anti-pathogen antibodies 41, are suspended into solution and align when a magnetic field 42 is applied so that they significantly reflect light from source 43 in detected direction 44, illuminating detector 45 when the solution is illuminated by source 43. As shown in FIG. 4B, when the pathogen 46 is present, the flakes can bind to spherical magnetic beads 47 also coated with antibodies. When the beads 47 attach to the flakes 40, the flakes 40 can no longer align themselves to the magnetic field 42, reflected beam 48 largely misses detector 45, and detected brightness is reduced, signaling the presence of the pathogen.

Turning now to FIG. 5, Scanning Electron Microscope (SEM) images show 40 nm particles bearing an antibody specific to RNA:DNA hybrids, bound to a surface bearing DNA probe sequences complimentary to the target microRNAs analyte, in the presence (A) and absence (B) of target microRNA sequence.

The following 32 examples represent some of the experimental demonstrations of the appended claims.

### EXAMPLE 1

Retroreflector cubes, five microns on a side, are fabricated as transparent polyimide cubes, are coated with gold on three mutually perpendicular surfaces, and are suspended into solution containing an opacifying substance which absorbs visible wavelengths of light. The gold surface is functionalized with dithiobis succinimide propionate molecules which bind to antibodies to a specific pathogen. A set of buoyant silica microbubbles with secondary antibodies to this pathogen is placed into the solution and binds to the cubes when the agent is present. The microbubbles are floated up to the top of the solution to an observation point and appear bright if they have a retroreflector bound to them by the pathogen.

### EXAMPLE 2

Fluorescent beads are placed on a surface and coated sequentially with Permalloy (or another magnetic film) and gold so that only about one hemisphere is optically opaque (Janus particles). The beads are placed in solution and the gold surfaces are functionalized with antibodies to a specific agent. When a magnetic field is applied, the spheres all orient themselves in the same direction so that the fluorescent material is blocked by the opaque layers from the excitation source and the solution looks dark. The particles are placed into a sample and are allowed to capture the agent. The agent bridges two spheres in such a way that they can no longer be oriented by the magnetic field to block the excitation radiation. The solution begins to emit a fluorescent signal that increases with the number of Janus particles no longer aligning with the magnetic field.

### EXAMPLE 3

Gold flakes (square or rectangular sheets of gold) with a magnetic core are suspended into solution and align when a magnetic field is applied so that they reflect light into a sensor when the solution is illuminated. The gold surfaces are decorated with antibodies to an agent. When the agent is present, the flakes can bind to spherical magnetic beads also coated with antibodies. When the beads attach, the flakes can no longer align themselves to the magnetic field and brightness is reduced.

### EXAMPLE 4

Magnetic retroreflectors are decorated with antibodies to cryptosporidium oocysts. When a magnetic field is applied, the cubes all orient themselves in such a way that they appear dark. When oocysts are present, the cubes link and can no longer be held in a position where they are completely dark. The intensity of the reflected light from the solution determines the concentration of the oocysts.

### EXAMPLE 5

Retroreflector cubes consisting of gold and polyimide are coated with antibodies to Norwalk virus. The cubes are placed in a specimen and Norwalk virus particles bind to the cubes if they are present. Magnetic beads, 200 nm in diameter, are also introduced into the solution and bind to the virus particles on the cube surfaces. A magnetic field is applied to separate the magnetic material from the solution. The retroreflector count in the captured material reveals the concentration of the Norwalk particles.

### EXAMPLE 6

Gold flakes with a magnetic core are suspended in 10 vol % glycerol as a viscosifying agent and have a specific maximum frequency at which they can rotate in the liquid when excited by a time-varying magnetic field. When large magnetic beads attach to the flakes in the presence of an antigen, this maximum rotational frequency is changed. A strobed imaging system, whose strobe frequency is a multiple of the frequency at which the flakes are rotated, is used to determine how many particles are no longer synchronized with the time-varying field. The rotational frequency is chosen to be low enough so that the isolated flakes can rotate with the field and high enough so that the flakes with attached beads cannot. The image captured appears like the random reflections from a snow globe, and the more random flakes can be detected, the larger the number of binding events between beads and flakes exists.

### EXAMPLE 7

Retroreflectors with a magnetic core, decorated with anti-pathogen antibodies are suspended into solution and have a specific maximum frequency at which they can rotate in the liquid when excited by a time-varying magnetic field. When retroreflectors associate in the presence of an antigen, this maximum rotational frequency is changed. A strobed imaging system, whose strobe frequency is a multiple of the frequency at which the retroreflectors are rotated, is used to determine how many retroreflectors are no longer synchronized with the time-varying field. The rotational frequency is chosen to be low enough so that the isolated retroreflectors can rotate with the field and high enough so that the associated retroreflectors cannot. The image captured appears like the random reflections from a snow globe, and the more retroreflectors can be detected, the larger the number of antigen-mediated binding events between retroreflectors which exists.

### EXAMPLE 8

One surface of a retroreflector, fabricated on a planar surface, is hinged and can be manipulated by an external magnetic field. The presence of a biomolecule will bind the lid into a position where the retroreflector is bright. Using a multitude of such retroreflectors, antigen concentration can be determined by counting the number of retroreflectors that cannot be turned off by applying the external magnetic field.

### EXAMPLE 9

Slightly-buoyant spherical particles 2.8 μm in diameter are decorated with antibodies to a target, and fluors, over their whole surface, and then the antibodies and fluors are destroyed on one side of the spheres using an ion beam. The spheres are mixed with a sample, and with gold nanoparticles bearing antibodies to the target. If the target is present, the nanoparticles weight the spheres such that they spend more time with their fluorescent side pointing down, and fluorescence observed from below is increased.

### EXAMPLE 10

Janus flakes containing magnetic material are decorated on one side with antibodies to E. coli bacteria and on the second side with a fluorescent material. When a pathogen is present, the flakes will bind together and the new particle will have fluorescent material on both sides. The particles are then extracted from the solution using a magnetic field and dried on a glass slide containing reference marks. By imaging the slide from both sides using a fluorescent camera, it can be determined if the fluorescence comes from one or both sides of any point on the slide. The data is used to quantify the E. coli bacteria concentrations.

### EXAMPLE 11

Janus flakes containing magnetic material on one side are decorated with a fluorescent material and with antibodies to E. coli bacteria on the second side. When a pathogen is present, the flakes will bind together and the new particle will have fluorescent material on neither side. The particles are then extracted from the solution using a magnetic field and dried on a glass slide containing reference marks. By imaging the slide using a fluorescence camera, it can be determined if the fluorescence comes from one or both sides of any point on the slide. The data is used to quantify the E. coli bacteria concentrations.

### EXAMPLE 12

Suspended microretroreflector cubes are used as labels to determine flow characteristics in microfluidics chips. A microscope with a reasonable depth of focus (about five microns) is used to record “slices” of a liquid in a microfluidics chip and observe the motion of the particles in solution. The microscope is attached to a flexure stage that is driven by a piezo-electric element to rapidly change the focus settings (and, hence, the slice of the volume that is visible). For a 30 frames per second camera and ten five micron slices in the channel, the complete volume can be scanned at a rate of about 2 Hz. The movement of the cubes can then be determined by looking at the relative position of the cubes as a function of time. Using this cube/volume imaging approach, an external magnetic field is applied to orient the cubes in the direction where they are nearly always bright. As long as the magnetic forces are substantially lower than the forces propelling the cubes through the liquid, the magnetic field will have little to no effect on the cube position in the channel. This balance can be disturbed by the analyte-mediated bridging of dense, magnetic, and/or buoyant particles onto the cubes, and the resulting changes in brightness used to infer the concentration of the analyte.

### EXAMPLE 13

A human blood sample is subjected to nucleic acid isolation by phenol/chloroform extraction and silica adsorption. The isolated nucleic acids are mixed with a suspension of 200 nm polyacrylamide particles decorated with DNA probe oligonucleotides specific to a particular microRNA, and then a suspension of 20 nm gold particles bearing an antibody specific to RNA/DNA hybrids is added. Single-particle tracking by light scattering is used to measure the scattering brightness and mobility of 10,000 particles. The presence and number of a lower-mobility, higher-scattering population of particles at higher fractional concentration than seen in a control sample containing only the two types of particles is used to infer the presence and concentration of the miRNA.

### EXAMPLE 14

A human blood sample is subjected to nucleic acid isolation by phenol/chloroform extraction and silica adsorption. The isolated nucleic acids are mixed with a suspension of 100 nm polyacrylamide particles decorated with DNA probe oligonucleotides specific to a particular viral sequence, and then a suspension of quantum dots bearing a second DNA probe to an adjacent sequence in the same virus is added. Single-particle tracking by fluorescence detection at the quantum dots' excitation/emission wavelengths is used to measure the fluorescence brightness and mobility of 1,000 fluorescent objects. The presence and number of a lower-mobility, higher-intensity population of particles (different from quantum dot dimers, which are observed at low but nonzero concentration) at higher fractional concentration than seen in a control sample containing only the quantum dots and the particles is used to infer the presence and concentration of the virus.

### EXAMPLE 15

A human blood sample is mixed with a suspension of quantum dots bearing an antibody to the coat protein of a hepatitis C virus. Single-particle tracking by fluorescence detection at the quantum dots' excitation/emission wavelengths is used to measure the fluorescence brightness and mobility of 1,000 fluorescent objects. The presence and number of a lower-mobility, higher-intensity population of particles (different from quantum dot dimers, which are observed at low but nonzero concentration) at higher fractional concentration than seen in a control sample containing only the quantum dots and uninfected control blood is used to infer the presence and concentration of the virus.

### EXAMPLE 16

A human blood sample is mixed with a suspension of quantum dots bearing an antibody to the coat protein of a hepatitis C virus. After 15 minutes, polyclonal antibody to hepatitis C virus and protein A conjugated to long-chain polyethylene glycol molecules are added and the mixture incubated 10 minutes. Single-particle tracking by fluorescence detection at the quantum dots' excitation/emission wavelengths is used to measure the fluorescence brightness and mobility of 1,000 fluorescent objects. The presence and number of a lower-mobility, higher-intensity population of particles (different from quantum dot dimers, which are observed at low but nonzero concentration) at higher fractional concentration than seen in a control sample containing only the quantum dots and uninfected control blood is used to infer the presence and concentration of the virus.

### EXAMPLE 17

Bridging two fluors. Cells from a fine-needle aspirate biopsy of a suspected lung tumor are detergent-lysed and centrifuged, and the supernatant mixed with fluorescein conjugated to an anti-protein antibody, and quantum dots having different excitation/emission wavelengths than fluorescein conjugated to an anti-phosphotyrosine antibody. Single-particle tracking by 2-color fluorescence detection at both fluorescein's and the quantum dots' excitation/emission wavelengths is used to measure the fluorescence brightness (at both colors) and mobility of 100,000 fluorescent objects. The presence and number of a lower-mobility population of particles with detectable fluorescence at both fluorescein and quantum dot emission/excitation wavelengths is used to infer the presence of the tyrosine-phosphorylated form of the protein.

### EXAMPLE 18

Scattering and fluorescence. Cells from a fine-needle aspirate biopsy of a suspected lung tumor are detergent-lysed and centrifuged, and the supernatant mixed with fluorescein conjugated to an anti-protein antibody, and 40 nm gold nanoparticles conjugated to an anti-phosphotyrosine antibody. Single-particle tracking by simultaneous, in-register fluorescence detection and scattering is used to measure the fluorescence and scattering brightness and mobility of 10,000 fluorescent objects. The presence and number of a lower-mobility population of scattering particles with detectable fluorescence at fluorescein emission/excitation wavelengths is used to infer the presence of the tyrosine-phosphorylated form of the protein.

### EXAMPLE 19

Competitive binding—50 nm magnetic nanoparticles displaying a single oligonucleotide probe. In presence of a ssDNA analyte these probes are occupied and become double-stranded. Particles bearing unhybridized oligo probes are captured by single-stranded binding protein immobilized on a microfluidic monolith through which the liquid is passed. Those that pass through are concentrated by electrophoresis against a polyacrylamide gel surface, then electrophoresed off the gel surface and counted.

### EXAMPLE 20

Protease release and count by SEM. A tumor biopsy specimen is macerated and centrifuged, and the extract placed in a 1536-well of a microtiter plate coated with a collagen/gold nanoparticle composite. After 30 min incubation at 37 C with gentle agitation, the liquid phase is transferred to another plate, centrifuged, the particles resuspended in distilled water, and the liquid spotted onto a conductive doped silicon wafer surface and particles counted by scanning electron microscopy. The number of particles found in a spot corresponding to a given specimen is used to infer the protease activity of that specimen.

### EXAMPLE 21

Protease release and count by scattering. A tumor biopsy specimen is macerated and centrifuged, and the extract placed in a 1536-well of a microtiter plate coated with a collagen/gold nanoparticle composite. After 30 min incubation at 37 C with gentle agitation, the liquid phase is transferred to another plate, centrifuged, and the particles resuspended in buffer and transferred to a single-particle counting apparatus. The number of particles found in the liquid corresponding to a given specimen is used to infer the protease activity of that specimen.

### EXAMPLE 22

Magnetic pull. A human blood sample is mixed with a suspension of quantum dots bearing an antibody to the coat protein of a hepatitis C virus. After 10 minutes, polyclonal antibody to hepatitis C virus conjugated to magnetic nanoparticles are added and the mixture incubated 10 minutes. Single-particle tracking by fluorescence detection at the quantum dots' excitation/emission wavelengths is used to measure the fluorescence brightness and mobility of 1,000 fluorescent objects. During each measurement, a pulsed electromagnet is used to deliver a transient magnetic field pulse to the sample, and the responsiveness of the particle then under observation to the magnetic pulse is observed. The presence and number of a lower-mobility, higher-intensity population of particles (different from quantum dot dimers, which are observed at low but nonzero concentration), with mobility responsive to the magnetic pulse, at higher fractional concentration than seen in a control sample containing only the quantum dots, magnetic nanoparticles, and uninfected control blood is used to infer the presence and concentration of the virus.

### EXAMPLE 23

Electrophoretic pull. A human blood sample is mixed with a suspension of quantum dots bearing an antibody to the coat protein of a hepatitis C virus. After 10 minutes, polyclonal antibody to hepatitis C virus conjugated to 5 nm nanoparticles decorated with polyanionic size-fractionated salmon sperm DNA are added and the mixture incubated 10 minutes. Single-particle tracking by fluorescence detection at the quantum dots' excitation emission wavelengths is used to measure the fluorescence brightness and mobility of 1,000 fluorescent objects. During each measurement, a pulsed power supply is used to deliver a transient electric field pulse to the sample, and the responsiveness of the particle then under observation to the pulse is observed. The presence and number of a population of fluorescent particles with mobility responsive to the electric pulse, at higher fractional concentration than seen in a control sample containing only the quantum dots, nanoparticles, and uninfected control blood, is used to infer the presence and concentration of the virus.

### EXAMPLE 24

Tethered, magnetic pull. The tethered particle motion (TPM) technique involves an analysis of the Brownian motion of a bead tethered to a passivated slide by a single polymer molecule. A human blood sample is mixed with a suspension of magnetic nanoparticles, each bearing an antibody to the coat protein of a known blood-born virus. After 10 minutes, the mixture is applied to a tethered-particle array, with the particles in each section of the array bearing spotted antibodies to different viruses.

Single-particle tracking by CCD darkfield microscopy is used to measure the mobility of the particles in each section of the array. During each measurement, a pulsed power supply is used to deliver a transient magnetic field pulse to the sample, and the responsiveness of the tethered particle then under observation to the pulse is observed. The presence of particles with mobility responsive to the magnetic pulse in the section array bearing antibodies to a given virus is used to infer the presence of that virus.

### EXAMPLE 25

Tethered, DNA competitive, magnetic pull. Total RNA isolated from a human blood sample is mixed with a suspension of magnetic nanoparticles, each bearing an oligonucleotide complementary to the sequence of a particular human microRNA. After 10 minutes, the mixture is applied to a tethered-particle surface, with each area of the arrayed surface bearing 200 nm polymer particles tethered to the surface by a DNA molecule bearing multiple copies of a sequence complementary to the sequence of particular microRNAs.

Single-particle tracking by CCD darkfield microscopy is used to measure the mobility of the particles in each section of the array. During each measurement, a pulsed power supply and electromagnet are used to deliver a transient magnetic field pulse to the sample, and the responsiveness of the tethered particles then under observation to the pulse is observed. The presence of a reduced number of particles with mobility responsive to the magnetic pulse is used to infer the presence of that miRNA.

### EXAMPLE 26

Tethered, drug competitive, array. A tethered-particle surface is fabricated with each area of the arrayed surface bearing 200 nm polymer particles bearing the human cell surface receptor for a virus tethered to the surface by a polymer molecule. To each area of the array is applied a suspension of the virus recognized by the receptor on the particles, mixed with a candidate virus-binding-inhibitor drug molecule of molecular mass below 2500 Da. Single-particle tracking by CCD darkfield microscopy is used to measure the mobility of the particles in each section of the array. Drugs delivered to areas of the array in which mobility is not reduced by the addition of the virus are candidates for inhibiting the virus/receptor interaction.

### EXAMPLE 27

Enhanced Viscosity. A human blood sample is subjected to nucleic acid isolation by phenol/chloroform extraction and silica adsorption. The isolated nucleic acids are mixed with a suspension of 200 nm polyacrylamide particles decorated with DNA probe oligonucleotides specific to a particular microRNA in 10 vol % glycerol as a viscosifying agent, and then a suspension of 20 nm gold particles bearing an antibody specific to RNA/DNA hybrids in 10 vol % glycerol as a viscosifying agent is added. Single-particle tracking by light scattering is used to measure the scattering brightness and mobility of 10,000 particles. The presence and number of a lower-mobility, higher-scattering population of particles at higher fractional concentration than seen in a control sample containing only the two types of particles is used to infer the presence and concentration of the miRNA.

### EXAMPLE 28

Shape-labeled binding assay with magnetic pull off and microscopic readout. The functionalized 40 nm magnetic nanoparticles with antibody having analyte specificity for DNA miRNA hybrids (see FIG. 1). This is an example of the use of magnetic particles as labels with force-enhanced specificity, and readout by microscopy. Particles of different sizes (e.g., 20 nm and 40 nm gold spheres), materials (e.g., silver and gold spheres), and shapes (rods, plus-signs, chiral or binary-encoded shapes) can be used for multiplexing. Force specificity (to discriminate against non-specifically localized labels) can be achieved by magnetic force, centrifugation, ultracentrifugation, buoyancy (e.g., with microbubbles), electrophoresis, capillary electrophoresis, dielectrophoresis, vibration or shock.

### EXAMPLE 29

For detection of proteins and phosphorylated proteins, for this purpose two-antibody sandwich assay format are used. For miRNA detection an immobilized DNA capture probe is used to capture the miRNA on the surface as an RNA:DNA hybrid, and nanoparticles bearing an antibody specific for RNA:DNA hybrids (not ss or ds DNA or RNA) to detect hybrid formation. (FIG. 1)

A mixed monolayer of discrete-length poly(ethylene) glycol (PEG) molecules is used to inhibit non-specific biomolecule adsorption onto the surface and to act as a linker to capture ligands. Gold-coated silicon wafers are cleaned and immersed in a solution of dithiobis (succinimidyl propionate) (DSP) to form a self assembled monolayer (SAM). After DSP forms SAM on Au surface by Au—S bonds, the NHS esters react with the primary amines of PEG molecules to form stable amide bonds. An amine-terminated PEG chain (MW 1000) is used as a non-specific cover and a longer amine-PEG chain (MW 3400) with a maleimide functional group is used as a long tether to present the DNA capture probe. The maleimide group on the long PEG captures a thiolated DNA which hybridizes to a complementary model miRNA. The RNA/DNA hybrid is confirmed by detecting 40 nm gold nanoparticles conjugated with AB 9.6 antibodies.

Any highly-sensitive assay can in practice be limited by background, e.g., by non-specific adsorption. We have developed chemistries for creating a universal low non-specific binding solid surface for immobilization of antibodies and DNA capture probes. Although the biotin-streptavidin system has routinely been the scheme of choice because of its extreme affinity, non-specificity issues have compromised assay sensitivity, and not been resolved by using avidin or neutravidin. The present invention overcomes these limitations by using discrete-length poly(ethylene) glycol (PEG) monolayers to inhibit non-specific biomolecule adsorption onto the surface and to act as a linker to capture ligands. The tethered molecules are highly active, behaving essentially as free molecules in solution due to the length and hydrophilic nature of the PEG moiety. More specifically, a mixed monolayer is formed using a mixture of long heterobifunctional PEG molecules with an active site for ligand attachment (e.g., NHS or maleimide for crosslinking between primary amines or sulfhydryl groups in proteins or nucleic acids) and an excess of short capped PEG molecules. The short PEG molecules are used to reduce crowding and thus eliminate any steric hindrance effects in the layer of the immobilized ligand.

### EXAMPLE 30

Magnetic force discrimination for specificity with nanoparticles. In this approach, the magnetic properties of the nanoparticles can be used to discriminate against non-specifically bound particles prior to detection by SEM, fluorescence microscopy or scanning probe microscopy (e.g., NSOM, MFM, STM, AFM, parallel multiprobe scanning microscopy). When the sample is exposed to a magnetic force greater than the strength of the non-specific interactions the non-specifically bound particles will be removed leaving only the specifically bound particles on the surface. In preliminary studies using hen egg lysozyme (HEL) and a well-characterized anti-HEL IgG antibody we showed that a force greater than 1000 picoNewtons (pN) was able to remove all of the bound particles, while a force of 200 to 250 pN gave the optimum discrimination between specifically and non-specifically bound particles. It is evident that extreme sensitivity can be rendered useless by non-specific background binding; the magnetic-specificity aspect of this platform represents a substantial advance in the development of ultrasensitive assays. Magnetic force can be delivered by a scanning probe with a fine point, as well as by electro- or permanent magnets. Force specificity to discriminate against non-specifically localized labels also can be achieved by centrifugation, ultracentrifugation, fluid shear, sonication, buoyancy (e.g., with microbubbles), electrophoresis, capillary electrophoresis, dielectrophoresis, vibration or shock.

### EXAMPLE 31

CD4 by cell flotation. An anticoagulated blood sample is mixed with buoyant microspheres which have been decorated with anti-CD4 antibodies and PEG passivated, and then allowed to float up into a narrow tube. The height of the resulting column of cells is used to infer the concentration of CD4 cells in the blood sample.

### EXAMPLE 32

CD4 by cell magnetic flotation. An anticoagulated blood sample is mixed with 1 micron superparamagnetic particles which have been decorated with anti-CD4 antibodies and PEG passivated, and then allowed to float up into a narrow tube under the action of a magnetic field. The height of the resulting column of cells is used to infer the concentration of CD4 cells in the blood sample.

Although certain embodiments of the present invention and their advantages have been described herein in detail, it should be understood that various changes, substitutions and alterations can be made without departing from the spirit and scope of the invention as defined by the appended claims.

Moreover, the scope of the present invention is not intended to be limited to the particular embodiments of the processes, machines, manufactures, means, methods and steps described herein. As a person of ordinary skill in the art will readily appreciate from this disclosure, other processes, machines, manufactures, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufactures, means, methods or steps.

TABLE 1
Extensions and Preferred Values of Major Parameters

| Parameter | Preferred |
|---|---|
| Particle | Retroreflector, scattering particle, fluorescent particle, |
| | phosphorescent particle, mirrored, flake, sphere, cube, |
| | retroreflector, insulator, conductor, bar-coded or labeled |
| | particle, porous particle, pellicular particle, solid particle, |
| | dilute particles, non-associating particles, charged |
| | particles |
| Force-responsiveness | Nanoparticle, gold particle, silver particle, polymer, drag |
| modifier | tag, magnetic particle, buoyant particle, microbubble, |
| | metal particle, charged moiety, dielectrophoresis tag, |
| | viscosifying agent, salt, temperature |
| Force | Brownian energy fluctuations, fluid shear, magnetic field, |
| | magnetic field gradient, centrifugal, field/flow |
| | fractionation, fluid flow, electrophoretic, dielectrophoretic, |
| | Coriolis, Maringoni effect force |
| Particle Material | Silicon Dioxide, with and without impurities (e.g., quartz, |
| | glass, etc.), Poly(methylmethacrylate), Polyimide, Silicon |
| | Nitride, gold, silver, quantum dot, CdS, carbon dot, |
| | phosphor, fluor, polymer, PMMA, polystyrene, pellicular, |
| | Janus particle |
| Reflective or scattering | Gold, silver, Aluminum, Platinum, Nickel, Molybdenum, |
| layer | Iridium, Rhenium, interference layer, dichroic, chromium |
| Modifications of label | Polarization modulator, optical rotation element, |
| | magnetic material, shape encoding, biocompatible |
| | surface coating, fluor, absorber, antenna, phosphor |
| Reflection Angle | Relative angle of cube walls, refractive index, mirror, |
| modulator | grating |
| Particle number | One to one trillion |
| Particle density | One to 1 billion per microliter |
| Particle loading with | One per particle to one trillion per particle |
| recognition element | |
| Particle shape | Sphere, flake, rod, star, caltrop, dumbbell, cube, |
| | rhomboid, trapezoid, sphere, hemisphere, parabolic, |
| | ellipsoid, cat's eye, mirror-backed lens, skew-side cube, |
| | rectangular solid, parabolic collector, diamond cut, |
| | encoded shape, chiral shape, unique non-symmetric |
| | shape, “7” shape with encoding bumps, assemble-able |
| | pieces, triangular rods, square rods. |
| Target Analyte | Cell surface receptor, protein, nucleic acid, mRNA, |
| | genomic DNA, PCR product, cDNA, peptide, hormone, |
| | drug, spore, virus, SSU RNAs, LSU-rRNAs, 5S rRNA, |
| | spacer region DNA from rRNA gene clusters, 5.8S rRNA, |
| | 4.5S rRNA, 10S RNA, RNAseP RNA, guide RNA, |
| | telomerase RNA, snRNAs -e.g. U1 RNA, scRNAs, |
| | Mitochondrial DNA, Virus DNA, virus RNA, PCR product, |
| | human DNA, human cDNA, artificial RNA, siRNA, |
| | enzyme substrate, enzyme, enzyme reaction product, |
| | Bacterium, virus, plant, animal, fungus, yeast, mold, |
| | Archae; Eukyarotes; Spores; Fish; Human; Gram- |
| | Negative bacterium, Y. pestis, HIV1, B. anthracis, |
| | Smallpox virus, Chromosomal DNA; rRNA; rDNA; cDNA; |
| | mt DNA, cpDNA, artificial RNA, plasmid DNA, |
| | oligonucleotides; PCR product; Viral RNA; Viral DNA; |
| | restriction fragment; YAC, BAC, cosmid, hormone, drug, |
| | pesticide, digoxin, insulin, HCG, atrazine, anthrax spore, |
| | teichoic acid, prion, chemical, toxin, chemical warfare |
| | agent, pollutant, Genomic DNA, methylated DNA, |
| | messenger RNA, fragmented DNA, fragmented RNA, |
| | fragmented mRNA, mitochondrial DNA, viral RNA, |
| | microRNA, in situ PCR product, polyA mRNA, RNA/DNA |
| | hybrid, protein, glycoprotein, lipoprotein, phosphoprotein, |
| | specific phosphorylated variant of protein, virus, |
| | chromosome |
| Sample | Blood sample, air filtrate, tissue biopsy, fine needle |
| | aspirate, cancer cell, surgical site, soil sample, water |
| | sample, whole organism, spore, genetically-modified |
| | reporter cells, Body Fluids (blood, urine, saliva, sputum, |
| | sperm, biopsy sample, forensic samples, tumor cell, |
| | vascular plaques, transplant tissues, skin, urine; feces, |
| | cerebrospinal fluid); Agricultural Products (grains, seeds, |
| | plants, meat, livestock, vegetables, rumen contents, milk, |
| | etc.); soil, air particulates; PCR products; purified nucleic |
| | acids, amplified nucleic acids, natural waters, |
| | contaminated liquids; surface scrapings or swabbings; |
| | Animal RNA, cell cultures, pharmaceutical production |
| | cultures, CHO cell cultures, bacterial cultures, virus- |
| | infected cultures, microbial colonies, FACS-sorted |
| | population, laser-capture microdissection fraction, |
| | magnetic separation subpopulation, FFPE extract |
| Sample preparation agent | acid, base, detergent, phenol, ethanol, isopropanol, |
| | chaotrope, enzyme, protease, nuclease, polymerase, |
| | adsorbent, ligase, primer, nucleotide, restriction |
| | endonuclease, detergent, ion exchanger, filter, ultrafilter, |
| | depth filter, multiwell filter, centrifuge tube, multiwell |
| | plate, immobilized-metal affinity adsorbent, |
| | hydroxyapatite, silica, zirconia, magnetic beads, Fine |
| | needle, microchannel, deterministic array |
| Sample preparation | Filter, Centrifuge, Extract, Adsorb, protease, nuclease, |
| method | partition, wash, de-wax, leach, lyse, amplify, |
| | denature/renature, electrophoresis, precipitate, |
| | germinate, Culture, PCR, disintegrate tissue, extract from |
| | FFPE, LAMP, NASBA, emulsion PCR, phenol extraction, |
| | silica adsorption, IMAC, filtration, affinity capture, |
| | microfluidic processing |
| Utility | Clinical Diagnosis; Prognosis, Pathogen discovery; |
| | Biodefense; Research; Adulterant Detection; Counterfeit |
| | Detection; Food Safety; Taxonomic Classification; |
| | Microbial ecology; Environmental Monitoring; Agronomy; |
| | Law Enforcement |
| Location | Well plate, filter, immunochromatographic assay, |
| | immunoassay, hybridization assay, biopsy specimen, in |
| | situ, in patient, in surgical incision, surface, cell surface, |
| | thin section, self-assembled array, in solution, in |
| | suspension, on a microfluidic chip |
| Recognition element | Antibody, nucleic acid, carbohydrate, aptamer, ligand, |
| | chelators, peptide nucleic acid, locked nucleic acid, |
| | backbone-modified nucleic acid, lectin, padlock probe, |
| | substrate, receptor, viral protein, mixed, cDNA, metal |
| | chelate, boronate, peptide, enzyme substrate, enzyme |
| | reaction product, lipid bilayer, cell, tissue, insect, |
| | microorganism, yeast, bacterium, anti-RNA/DNA hybrid |
| | antibody, mutS, anti-DNA antibody, anti-methylation |
| | antibody, anti-phosphorylation antibody |
| Immobilization chemistry | Avidin/biotin, amine, carbodiimide, thiol, gold/thiol, metal |
| | chelate affinity, aldehyde, mixed-ligand, adsorptive, |
| | covalent, SAM, DSP, EDC, Trauton's reagent |
| Size | 1 nm-3 mm |
| Surface coating | Antibody, nucleic acids, PEG, dextran, protein, polymer, |
| | lipid, metal, glass |
| Illumination | Laser, xenon lamp, LED, arc lamp, mercury lamp, |
| | incandescent, fluorescent, scanned, time-modulated, |
| | frequency-modulated, chopped, time-gated, polarized, |
| | infrared, visible, UV, CDMA encoded, multiangle, ring |
| Detection | Eye, camera, digital camera, PMT, scanner, microscope, |
| | telescope, detector array, time-gated, chopped, |
| | frequency-modulated, wavelength-filtered, polarization- |
| | sensitive, Raman, Surface-enhanced Raman, high |
| | numerical aperture, color-sensitive, lifetime, FRET, |
| | FRAP, intensified, phosphorescence, resistivity, |
| | ellipsometer, high-density CCD, in flow, on surface, in |
| | suspension |
| Detection volume | 1 fL to 3 mL |
| Additions | Prodrug, drug candidate, fluor, pro-fluor, nanoparticle, |
| | molecular beacon, nanoshell, proenzyme, quencher, |
| | genomic DNA sequence, opacifier |

1. A method of assaying an analyte in a liquid comprising the steps of:
a. contacting the analyte with a plurality of particles of diameter less than 3 mm, said particles being capable of interacting with the analyte by binding, adsorption or reaction;
b. observing the motion of some or all of the particles by optical, fluorescence, or other electromagnetic measurement techniques; and
c. using the presence of particles with differing motion to infer the presence or concentration of the analyte.

2. The method of claim 1 further comprising observing the fluorescence, fluorescence lifetime, phosphorescence, reflection, polarization, scattering, absorbance, chemiluminescence, or magnetic properties of some or all of the particles.

3. The method of claim 1 further comprising increasing the detectability of analyte-induced changes in particle motion or fluorescence, fluorescence lifetime, phosphorescence, reflection, polarization, scattering, absorbance, chemiluminescence, or magnetic properties of some or all of the particles by application of one or more additional reagents.

4. The method of claim 1 further comprising increasing the detectability of analyte-induced changes in particle motion or fluorescence, fluorescence lifetime, phosphorescence, reflection, polarization, scattering, absorbance, chemiluminescence, or magnetic properties of some or all of the particles by application of one or more force fields.

5. The method of claim 1 further comprising associating some or all of the particles with a surface in a manner which permits motion.

6. The method of claim 1 further comprising particle tracking, single-particle tracking or tethered-particle motion tracking.

7. The method of claim 1 in which the motion of the particles comprises Brownian motion.

8. The method of claim 1 in which the motion of the particles comprises electrophoretic, dielectrophoretic, sedimentation, or sedimentation motion.

9. The method of claim 2 further comprising detecting of light emission at more than one wavelength.

10. The method of claim 2 further comprising detecting of fluorescence emission resulting from resonance energy transfer.

11. The method of claim 2 further comprising detecting of both light scattering and fluorescence.

12. The method of claim 1 further comprising observing of the particles by eye, or by camera, digital camera, PMT, scanner, microscope, telescope, detector array, time-gated, chopped, frequency-modulated, wavelength-filtered, polarization-sensitive, Raman, Surface-enhanced Raman, high numerical aperture, color-sensitive, lifetime, FRET, FRAP, intensified, phosphorescence, resistivity, ellipsometer, or high-density CCD observation, in flow, on a surface, or in suspension.

13. The method of claim 1 in which the particles comprise one or more of polymers, cells, bacteria, nanoparticles, microparticles, gold, silver, silica, magnetic material, polystyrene, acrylate, poly(ethylene glycol), quantum dots, fluors, phosphors, dyes, protein, an antibody, nucleic acids, PEG, dextran, a polymer, a lipid, a metal, or glass.

14. The method of claim 1 in which the particles comprise one or more of an antibody, nucleic acid, carbohydrate, aptamer, ligand, chelator, peptide nucleic acid, locked nucleic acid, backbone-modified nucleic acid, lectin, padlock probe, substrate, receptor, viral protein, mixed, cDNA, metal chelate, boronate, peptide, enzyme substrate, enzyme reaction product, lipid bilayer, cell, tissue, insect, microorganism, yeast, bacterium, anti-RNA/DNA hybrid antibody, mutS, anti-DNA antibody, anti-methylation antibody, or an anti-phosphorylation antibody.

15. The method of claim 1 in which the temperature of the observation volume is controlled.

16. (canceled)

17. (canceled)

18. The method of claim 1 in which the analyte competes with a species that also can bind to the particle by the same mechanism.

19. The method of claim 1 in which binding of the analyte facilitates binding of a labeling species to the particle.

20. The method of claim 1 in which the analyte is a cell surface receptor, protein, nucleic acid, mRNA, genomic DNA, PCR product, cDNA, peptide, hormone, drug, spore, virus, SSU RNAs, LSU-rRNAs, 5S rRNA, spacer region DNA from rRNA gene clusters, 5.8S rRNA, 4.5S rRNA, 10S RNA, RNAseP RNA, guide RNA, telomerase RNA, snRNA, U1 RNA, scRNAs, mitochondrial DNA, virus DNA, virus RNA, PCR product, human DNA, human cDNA, artificial RNA, siRNA, enzyme substrate, enzyme, enzyme reaction product, bacterium, virus, plant, animal, fungus, yeast, mold, Archael organism, eukyarote, spore, fish, human, Gram-negative bacterium, Y. pestis, HIV-1, B. anthracis, smallpox virus, chromosomal DNA, rRNA, rDNA, cDNA, mt DNA, cpDNA, artificial RNA, plasmid DNA, oligonucleotides, PCR product, viral RNA, Viral DNA, restriction fragment, YAC, BAC, cosmid, hormone, drug, pesticide, digoxin, insulin, HCG, atrazine, anthrax spore, teichoic acid, prion, chemical, toxin, chemical warfare agent, pollutant, genomic DNA, methylated DNA, messenger RNA, fragmented DNA, fragmented RNA, fragmented mRNA, mitochondrial DNA, viral RNA, microRNA, in situ PCR product, polyA mRNA, RNA/DNA hybrid, protein, glycoprotein, lipoprotein, phosphoprotein, specific phosphorylated variant of a protein, virus, or chromosome.

21. The method of claim 1 in which binding of the analyte facilitates binding of a catalytic species to the particle, and that catalytic species catalyzes a reaction that alters the motion, field-responsiveness, fluorescence, fluorescence lifetime, phosphorescence, reflection, polarization, scattering, absorbance, chemiluminescence, or magnetic properties of the particle.

22. (canceled)

23. (canceled)

24. The method of claim 1 in which the motion of at least 300 particles is observed.

25. (canceled)

26. The method of claim 1 in which the motion of at least 30,000 particles is observed.

27. (canceled)

28. (canceled)

29. (canceled)

30-52. (canceled)
